(19) United States
(12) Patent Application Publication
(10) Pub. No.: US 2026/0194147 A1
(43) Pub. Date: Jul. 9, 2026

(54) OPTIMIZING VALVE PLUG AND VALVE STEM DESIGN FOR USE IN VALVES

(71) Applicant: Dresser, LLC, Houston, TX (US)

(72) Inventors: Aurelien Thomas Jules Reau, Flers (FR); Romain Francois Pierre Chenu, Conde-sur-Noireau (FR); Valentin Mercier, Flers (FR); Arnaud Riviere, Couvains (FR); Mickael Olaya, Valdalliere (FR)

(21) Appl. No.: 19/574,643

(22) Filed: Mar. 23, 2026

Related U.S. Application Data
(62) Division of application No. 18/761,409, filed on Jul. 2, 2024.

(51) Int. Cl. F16K 3/26

(52) U.S. Cl. CPC F16K 3/267

(57) ABSTRACT

A regulating assembly with a valve stem and a valve plug is configured for use in a valve. The configurations may optimize natural frequency to address concerns that operators have with vibrations in devices on their process lines. The valve plug may have a body that narrows from the top and the bottom towards its midline to form an hourglass shape. Reinforcing structure may find use to strengthen or stiffen the body without adding additional mass to the device. This reinforcing structure may include ribs, for example, that circumscribe the center axis. A matrix or lattice structure may prevail as the reinforcing structure as well.

### CROSS REFERENCE TO RELATED APPLICATIONS

This application is a divisional of U.S. Ser. No. 18/761,409, filed on Jul. 2, 2024, and entitled “OPTIMIZING VALVE PLUG AND VALVE STEM DESIGN FOR USE IN VALVES.” The content of this application is incorporated by reference in its entirety herein.

### BACKGROUND

Flow controls play a significant role in many industrial settings. Power plants and industrial process facilities, for example, use different types of flow controls to manage flow of material, typically fluids, throughout vast networks of pipes, tanks, generators, and other equipment. Valves are a type of flow control that operators favor to regulate flow of material (or “process fluid”) on their process lines. These devices may comprise a valve body that houses valve “trim,” typically a cage, a closure member, and a seat. A superstructure like a bonnet (or cover) may secure to the valve body. The bonnet may have a through-bore to receive a valve stem that connects the closure member to an actuator. Packing material may reside in the through-bore and surround the valve stem to prevent any leak of process fluid that might escape the valve body into the through-bore.

### SUMMARY

The subject matter of this disclosure relates to improvements to the construction of valves and other flow controls. Of particular interest are embodiments of a regulating assembly that includes, for example, the valve stem and valve plug of a valve. These embodiments may adopt designs that optimize natural frequency to address concerns that operators have with vibrations in devices on their process lines. Vibration can create noise, for example, that exceeds nominal safe limits for personnel in proximity to the device. Vibration can also introduce control issues that can impact process parameters. Even small vibrations can damage the valve plug or the valve stem (as well as the packing material), propagate cracks in these parts, or generally reduce service life of flow controls. These problems may, in turn, require operators to accelerate maintenance on devices, which can increase their capital costs for parts and labor, as well as require costly downtime of their process lines.

### DRAWINGS

This specification refers to the following drawings:

FIG. 1 depicts a schematic diagram of an exemplary embodiment of a regulating assembly;

FIG. 2 depicts an elevation view of the cross-section of an example of a valve plug for the regulating assembly of FIG. 1;

FIG. 3 depicts an elevation view of the cross-section of an example of a valve plug for the regulating assembly of FIG. 1;

FIG. 4 depicts an elevation view of the cross-section of an example of a valve plug for the regulating assembly of FIG. 1;

FIG. 5 depicts a plan view of the cross-section of the example of FIG. 4;

FIG. 6 depicts an elevation view of the cross-section of an example of a valve plug for the regulating assembly of FIG. 1;

FIG. 7 depicts a plan view of the cross-section of the example of FIG. 6;

FIG. 8 depicts a perspective view of an example of a flow control; and

FIG. 9 depicts an elevation view of the cross-section of part of the example of FIG. 8.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, this should not exclude plural of any such designation, unless the specification explicitly recites or explains such exclusion. Likewise, any references to “one embodiment” or “one implementation” does not exclude the existence of additional embodiments or implementations that also incorporate the recited features.

### DESCRIPTION

The discussion now turns to describe features of the examples shown in the drawings noted above. It is not uncommon for flow controls to adopt specific or purpose-driven designs to satisfy operator requirements for their process lines. These designs may deviate from dimensions, construction, materials, or other factors, which can increase cost or complexity, as well as introduce other potential problems into the device. The examples below introduce structure for the valve plug and the valve stem with mechanical properties, like mass, mass distribution, weight, or stiffness, to achieve appropriate natural frequency to reduce or mitigate vibrations that can occur in the field. One benefit of the proposed approach is that it may result in designs that adopt unique geometry for the valve plug or a smaller diameter for the valve stem. These designs may, in turn, reduce the size of other parts, for example, the bonnet, the packing material, or the actuator, which can reduce costs to manufacture the device. Designs in which the valve plug or the valve stem is smaller or “lighter” can also improve product reliability or service life, for example, by reducing wear or friction between the valve stem and the packing material. Other embodiments are within the scope of this disclosure.

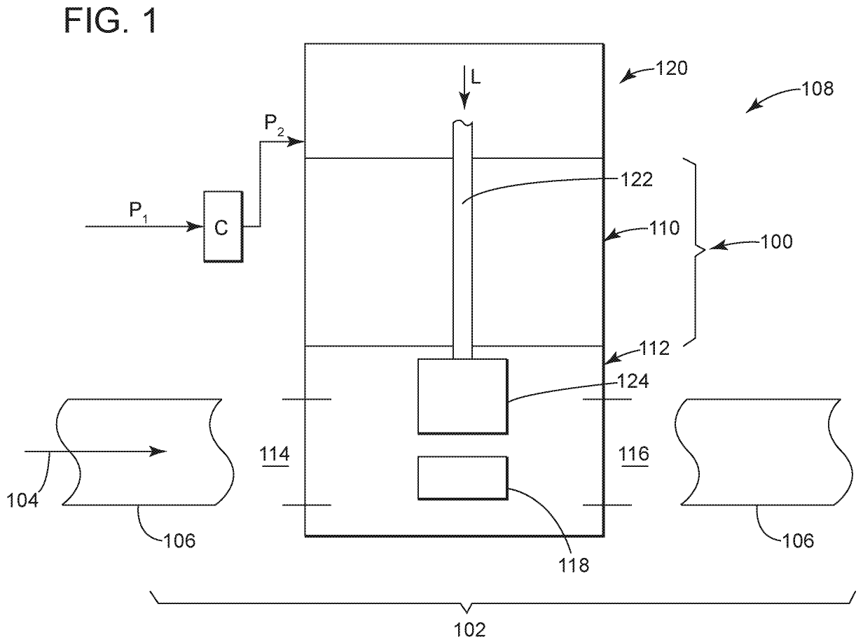

FIG. 1 depicts a schematic diagram of an exemplary embodiment of a regulating assembly 100. This embodiment is part of a distribution network 102, typically designed to carry material 104 through conduit 106. In one implementation, the regulating assembly 100 is part of a flow control 108 that may integrate into the network 102. The flow control 108 may include a superstructure 110. As shown, a valve body 112 with openings (e.g., an inlet 114 and an outlet 116) may reside on one side of the superstructure 110. A seat 118 may reside inside of the valve body 112. An actuator 120 may couple with the other side of the superstructure 110. In one implementation, the regulating assembly 100 may include a valve stem 122 with a first end that couples with the actuator 120. A second end of the valve stem 122 may couple with a valve plug 124.

Broadly, the regulating assembly 100 may be configured to reduce or mitigate vibration. These configurations may meet operator requirements to perform in conditions that prevail on their process lines. High pressure or temperatures, caustic materials, or high flow rates are just a few of many variables that manufacturers must consider for their designs. The proposed designs adopt extremely robust construction that is necessary to ensure long-lasting life. However, these designs also optimize natural frequency to mitigate vibration or sensitivity of parts to other operating conditions on the flow control. These features can prevent potential failures and, at the same time, avoid additional expenses or complexity in manufacture of the device.

The distribution system 102 may be configured to deliver or move fluids. These configurations may embody vast infrastructure. Material 104 may comprise gases, liquids, solid-liquid mixes, or liquid-gas mixes, as well. The conduit 106 may include pipes or pipelines that often connect to pumps, boilers, and the like. The pipes 106 may also connect to tanks or reservoirs. In many facilities, this equipment forms complex networks to execute a process, like refining raw materials or manufacturing a product.

The flow control 108 may be configured to regulate flow of material 104 through the conduit 106 in these complex networks. These configurations may include different types of valves, control valves, and like devices. Control valves may include a controller C that is configured to process and generate signals. The controller C may connect to a control network (or “distributed control system” or “DCS”). This network may maintain operation of all devices on process lines to ensure that materials flow in accordance with a process or meets certain process parameters. The DCS may generate control signals with operating parameters that describe or define operation of the flow control 108 for this purpose. Operating hardware in the controller C may employ electrical and computing components (e.g., processors, memory, executable instructions, etc.). These components may also include electro-pneumatic devices that operate on incoming pneumatic supply signal P1, typically instrument air at process facilities. These components may generate an outgoing actuator control signal P2 appropriate for the flow control 108 to supply material 104 downstream according to process parameters.

The superstructure 110 may be configured to support components of the flow control 108. These configurations may include a “bonnet” or “yoke” that couples to the valve body 112, which is often made of cast or machined metals. The valve body 112 may have flanges or another connective feature at the openings 114, 116. Adjacent pipes 106 may connect or bolt to these flanges to allow material 104 to flow into and out of the device. The valve seat 118 may adopt construction that allows the flow control 108 to operate under extreme conditions, including with materials 104 that are caustic or hazardous. In one implementation, the actuator control signal P2 may pressurize the inside of the actuator 120. The pressure works with other components in the actuator 120 (like springs and diaphragms) to generate a load L on the valve stem 122. The load L may set the operating condition on the flow control 108, which in turn regulates flow of material 104 through the device to satisfy requirements on the process line.

The parts 122, 124 may be configured to optimize its properties to mitigate vibration. The valve stem 122 may embody an elongated member, for example, a metal rod or shaft that can direct load L from the actuator 120 to the valve plug 124. This shaft may have a cross-section that is round or circular; but other shapes may find use in certain applications as well. The valve plug 124 may have a body that is made of metal or like robust materials. This body may adopt a shape or geometry that reduces its mass but does not compromise its use in a wide range of applications. Examples of the geometry may incorporate a “hybrid” design that may include multiple pieces, different materials, or other combinations of design features to provide the regulating assembly 100 with properties (e.g., natural frequency, stiffness, mass, etc.) the design needs to meet operator requirements.

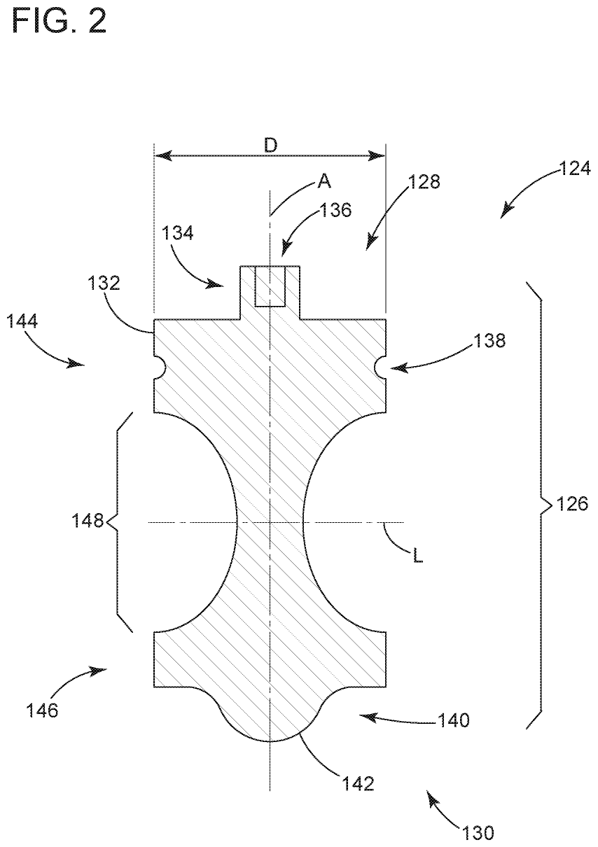

FIG. 2 depicts an elevation view of the cross-section from the side of exemplary structure for the body of the valve plug 124. This structure may include a cylindrical member 126 with a top 128, a bottom 130, and a center axis A. Its outer surface 132 may have an outer diameter D. At the top 128, the cylindrical member 126 may form a first protrusion 134 that has a bore 136 with an inner diameter to receive the valve stem 122 therein. An annular groove 138 may penetrate the outer surface 132 and, in one example, circumscribe the axis A. At the bottom 130, the cylindrical member 126 may have a second protrusion 140, shown here as a rounded peak 142. In one implementation, the diameter D may vary longitudinally along the axis A to define a shape for the cylindrical member 126. This shape may correspond with an hourglass shape that has, for example, an upper disc portion 144, a lower disc portion 146, and an intermediate portion 148 found therebetween. The outer diameter D at the disc portions 144, 146 may remain constant. This feature may result in a portion of the outer surface 128 that is parallel (or essentially parallel) with the axis A. The outer diameter D in the intermediate portion 148 may decrease to narrow the cylindrical member 126 from the upper disc portion 144 to a midline L. The diameter D may increase to widen the cylindrical member 126 from the midline L to the lower disc portion 144.

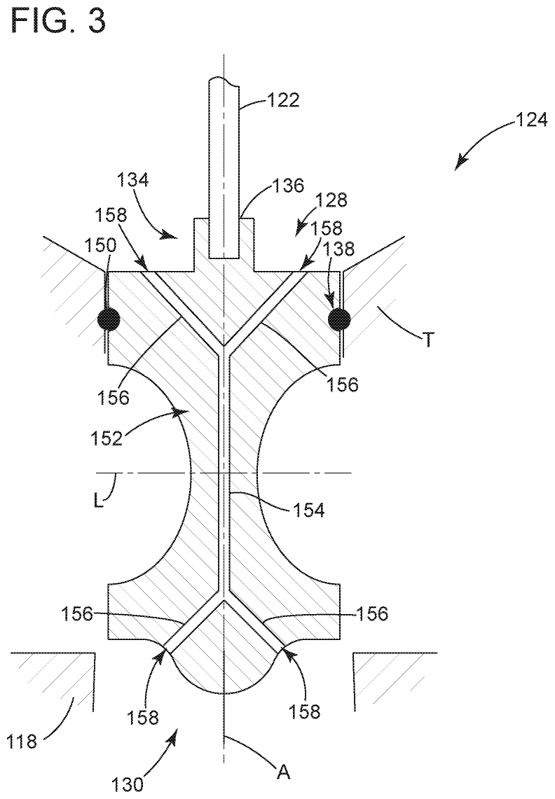

FIG. 3 depicts an elevation view of the cross-section from the side of an example of the valve plug 124 of FIG. 2. A seal 150 may reside in the annular groove 138. The seal 150 may embody an O-ring or like element that, in use, may contact a surface of cage T to form a seal. The body of the valve plug 124 may also incorporate an internal flow pathway 152 that may find use to balance pressure across the top 128 and the bottom 130 of the valve plug 124. The pathway 152 may have a central passage 154 that extends longitudinally along the axis A. Branches 156 may extend from the central passage 154. The branches 156 may terminate at openings 158, shown here on both the top 128 and the bottom 130 of the valve plug 124 and disposed diametrically opposite one another across the axis A. In use, the pressure-balanced design may reduce force necessary to open and close the valve plug 124 in relation to the seat 118.

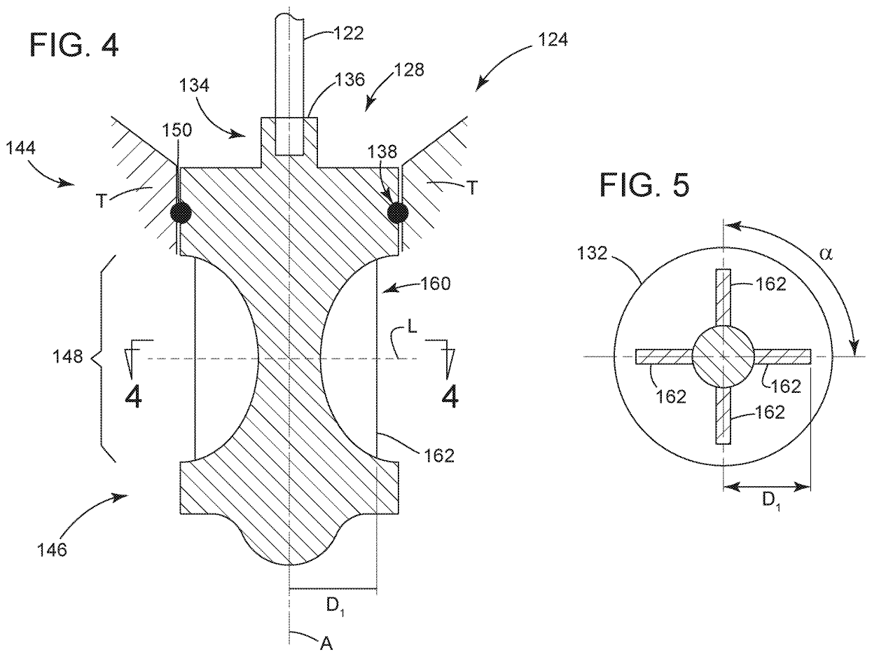

FIG. 4 depicts an elevation view of the cross-section from the side of an example of the valve plug 124 of FIG. 2. The valve plug 124 may also include a reinforcing structure 160 that is configured to stiffen or strengthen the hourglass shape. These configurations may adopt structure that resides in the intermediate portion 148 of the cylindrical member 126. This structure may also completely or partially circumscribe the axis A. Examples of the structure may also add little or negligible mass to the valve plug 124. In one implementation, the reinforcing structure 160 may embody one or more ribs 162 that couple with the outer surface 132. The ribs 162 may extend longitudinally on either side the midline L. The ribs 162 may also extend radially away from the center axis A to a distal surface that is found a distance D1 from the axis A. In one implementation, the distance D1 is the same as the diameter D of the cylindrical member 126. FIG. 5 depicts a plan view of the cross-section along 4 -4 of the valve plug 124 of FIG. 4. Here, the design is shown to include four of the ribs 162. However, this disclosure contemplates that more or less of the ribs 162 may prevail as well. An angle a may set an angular position for the ribs 162 about the axis A. In this example, the angle a may be around 90°. Values for the angle a may also vary to optimize the natural frequency, the stiffness, or other parameters of the design.

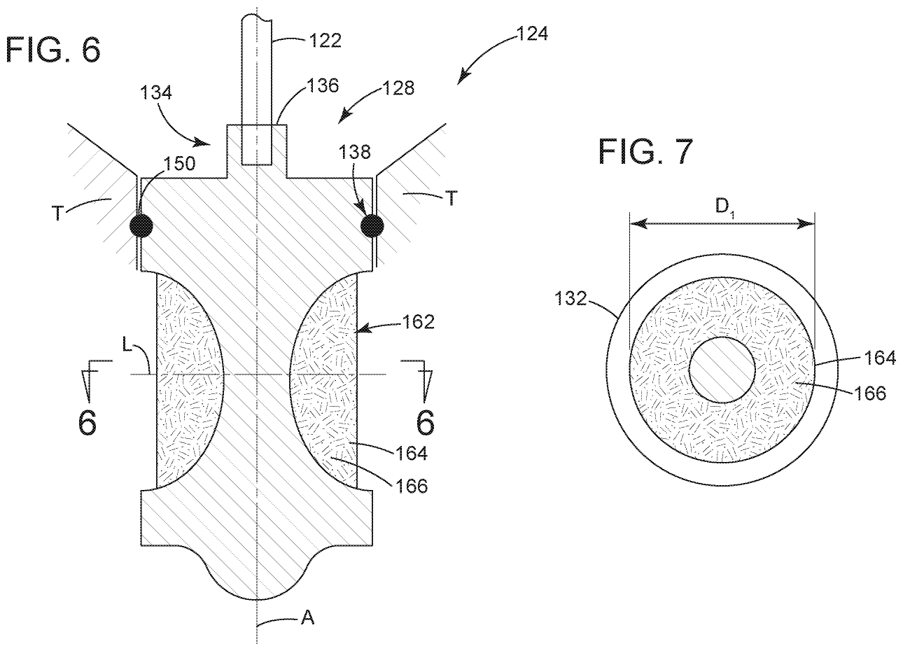

FIGS. 6 and 7 depict an elevation view of the cross-section from the side of an example of the valve plug 124 of FIG. 2. The reinforcing structure 160 may embody a matrix 164 in the intermediate portion 148 of the cylindrical member 126. The matrix 164 may comprise a lattice that fills all or part of the intermediate portion 146 of the cylindrical member 126. The distance D1 may measure the distal side of the matrix 164 and, as noted above, may vary as necessary to optimize the design. As also shown, the lattice structure may form cells 166, which may be empty or hollow voids in the structure. However, in one implementation, material may fill the voids in the matrix 164.

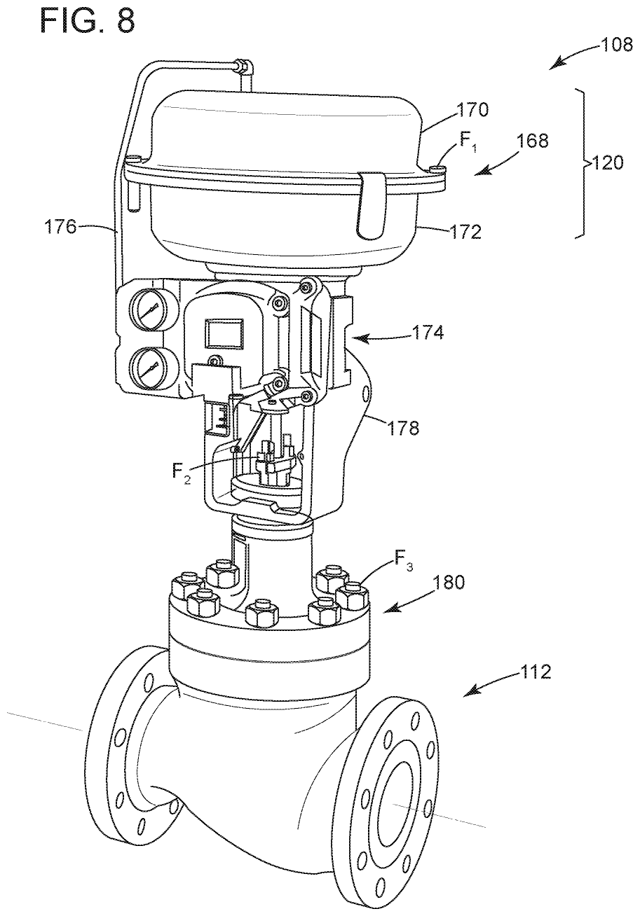

FIG. 8 depicts a perspective view of exemplary structure for the flow control 108. The actuator 120 may have a bulbous enclosure 168 that may comprise two pieces 170, 172. Fasteners F1 may clamp the pieces 170, 172 about their edges to seal the enclosure 168. This arrangement may entrap a diaphragm around its periphery. A piston assembly may also reside inside of the sealed enclosure 168. A controller 174 may attach to the bulbous enclosure 168 by way of a conduit 176. This arrangement permits flow of a pneumatic signal from the controller 174 to pressurize (and depressurize) the actuator 120. The controller 174 may attach to a yoke 178, which itself affixes to a bonnet 180 using fasteners F2. The bonnet 180 may couple to the valve body 112 with fasteners F3.

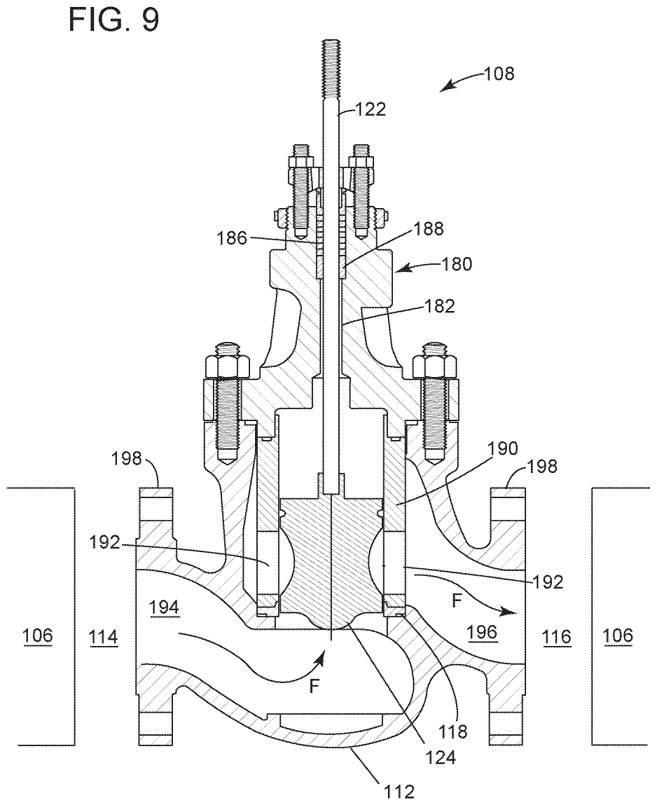

FIG. 9 depicts an elevation view of the cross-section from the side of part of the structure of FIG. 8. The bonnet 180 may have a through-bore 182 to receive the valve stem 122 therein. The valve stem 122 may extend through packing material 186 and a guide bushing 188. The device may include valve trim, shown here with a cylindrical cage 190 that surrounds the valve plug 124. Openings 192 on either side of the cage 190 can allow flow F to transit through the seat 118 from a first path 194 to a second path 196 in the valve body 112. Flanges 196 at the openings 114, 116 may allow conduits 106 to couple with the valve body 112.

This specification may include and contemplate other examples that occur to those skilled in the art. These other examples fall within the scope of the claims, for example, if they have structural elements that do not differ from the literal language of the claims, or if they include equivalent structural elements with insubstantial differences from the literal language of the claims.

What is claimed is:

1. A valve, comprising:
an actuator;
a valve stem having a first end and a second end, the first end coupled to the actuator; and
a valve plug coupled to the second end of the valve stem, the valve plug comprising a body having a top, a bottom, and a shape that narrows at its midline; and
a valve seat,
wherein the body is configured to balance pressure across the top and the bottom with the body engaged with the valve seat.

2. The valve of claim 1, further comprising:
an internal flow pathway in the body that allows flow of fluid from the top to the bottom of the body.

3. The valve of claim 1, further comprising:
an internal flow pathway terminating at openings found at the top and the bottom of the body.

4. The valve of claim 1, further comprising:
an internal flow pathway extending along a centerline of the body.

5. The valve of claim 1, further comprising:
an internal flow pathway comprising a first part extending along a centerline of the body and a second part extending at an angle to the centerline and terminating at an opening at the top or the bottom of the body.

6. The valve of claim 1, further comprising:
an internal flow pathway comprising a central pathway terminating at a first branch extending to an opening at the top of the body and a second branch extending to an opening at the bottom of the body.

7. The valve of claim 1, further comprising:
an internal flow pathway comprising a central pathway terminating at a first set of branches extending to openings at the top of the body and a second set of branch extending to an opening at the bottom of the body.

8. The valve of claim 1, further comprising:
an internal flow pathway terminating at openings at the top and the bottom,
wherein the openings are disposed on opposing sides of a center axis of the body.

9. The valve of claim 1, wherein the shape forms an hourglass.

10. The valve of claim 1, wherein the body has a center axis and an outer surface that curves inwardly towards the center axis.

11. A valve, comprising:
a valve plug having a top and a bottom, the valve plug comprising:
a body with an outer surface having a cross-section of an hourglass; and
an internal flow pathway that extends from the top to the bottom.

12. The valve of claim 11, further comprising:
openings that allow access to the internal flow pathway.

13. The valve of claim 11, further comprising:
openings at the top and the bottom of the valve plug,
wherein the internal flow pathway terminates at the openings.

14. The valve of claim 11, wherein the internal flow pathway directs fluid along a centerline of the body.

15. The valve body of claim 11, further comprising:
an annular groove circumscribing the body.

16. The valve of claim 11, further comprising:
an O-ring disposed around the body.

17. A valve, comprising:
a pressure-balanced plug having a top and a bottom, the pressure-balanced plug comprising a body with an hourglass shape.

18. The valve of claim 17, further comprising:
a bore extending through the body with openings at the top and the bottom.

19. The valve of claim 17, further comprising:
a cage,
wherein the pressure-balanced plug is configured to seal against the cage.

20. The valve of claim 17, further comprising:
a cage; and
a seat,
wherein the pressure-balanced plug is configured to move inside of the cage and relative to the seat.
